(19) United States
(12) Patent Application Publication
(10) Pub. No.: US 2026/0045270 A1
(43) Pub. Date: Feb. 12, 2026

(54) AUDIO SYNTHESIS METHOD AND APPARATUS, ELECTRONIC DEVICE, MEDIUM, AND PROGRAM PRODUCT

(71) Applicant: Beijing Zitiao Network Technology Co., Ltd., Beijing (CN)

(72) Inventor: Shichao GE, Beijing (CN)

(21) Appl. No.: 19/273,918

(22) Filed: Jul. 18, 2025

(30) Foreign Application Priority Data
Aug. 8, 2024 (CN) 202411087748.X

(51) Int. Cl. G10L 21/0364; G10L 21/034; G10L 25/18; G10L 25/21

(52) U.S. Cl. CPC G10L 21/0364; G10L 21/034; G10L 25/18; G10L 25/21

(57) ABSTRACT

The present disclosure relates to the technical field of music engineering, and provides an audio synthesis method and apparatus, an electronic device, a medium, and a program product. The present disclosure provides an audio synthesis method, including: acquiring a first human voice audio and an accompaniment audio from reference audio; determining a first loudness range based on loudness of the first human voice audio; acquiring second human voice audio corresponding to the reference audio; determining a second loudness range based on loudness of the second human voice audio; adjusting the loudness of the second human voice audio based on a first comparison result between the second loudness range and the first loudness range to obtain first target human voice audio; and mixing the first target human voice audio and the accompaniment audio to obtain target audio.

### CROSS-REFERENCE TO RELATED APPLICATION

This application claims the priority to and benefits of the Chinese Patent Application, No. 202411087748.X, which was filed on Aug. 8, 2024. The aforementioned patent application is hereby incorporated by reference in its entirety.

### TECHNICAL FIELD

The present disclosure relates to the technical field of music engineering, and more particularly relates to an audio synthesis method and apparatus, an electronic device, a medium, and a program product.

### BACKGROUND

In the related art, in order to mix and synthesize human voice with accompaniment, a professional audio engineer is required to perform manual synthesis by utilizing a system and software involving digital signal processing (DSP), which not only has tight professional restrictions, but also results in low efficiency of audio synthesis due to a long synthesis duration.

### SUMMARY

In view of this, the present disclosure provides an audio synthesis method and apparatus, electronic device, medium and program product, so as to solve the problem of low audio synthesis efficiency.

In a first aspect, the present disclosure provides an audio synthesis method, and the method includes: acquiring a first human voice audio and an accompaniment audio from reference audio; determining a first loudness range based on loudness of the first human voice audio; acquiring second human voice audio corresponding to the reference audio; determining a second loudness range based on loudness of the second human voice audio; adjusting the loudness of the second human voice audio based on a first comparison result between the second loudness range and the first loudness range to obtain first target human voice audio; and mixing the first target human voice audio and the accompaniment audio to obtain target audio.

In a second aspect, the present disclosure provides an audio synthesis apparatus, and the apparatus comprises: a first acquisition module configured to acquire first human voice audio and an accompaniment audio from reference audio; a first processing module configured to determine a first loudness range based on loudness of the first human voice audio; a second acquisition module configured to acquire second human voice audio corresponding to the reference audio; a second processing module configured to determine a second loudness range based on loudness of the second human voice audio; a first adjustment module configured to adjust the loudness of the second human voice audio based on a first comparison result between the second loudness range and the first loudness range to obtain first target human voice audio; and a synthesis module configured to mix the first target human voice audio and the accompaniment audio to obtain target audio.

In a third aspect, the present disclosure provides an electronic device, and the electronic device includes: a memory and a processor, wherein the memory and the processor are communicatively connected to each other, the memory comprises computer instructions stored therein, and the processor executes the computer instructions to execute the audio synthesis method according to the first aspect described above or any corresponding embodiment thereof.

In a fourth aspect, the present disclosure provides a computer-readable storage medium, having computer instructions stored thereon, wherein the computer instructions are configured to cause a computer to execute the audio synthesis method according to the first aspect described above or any corresponding embodiment thereof.

In a fifth aspect, the present disclosure provides a computer program product, comprising computer instructions, wherein the computer instructions are configured to cause a computer to execute the audio synthesis method according to the first aspect described above or any corresponding embodiment thereof.

### BRIEF DESCRIPTION OF DRAWINGS

In order to more clearly illustrate the specific embodiments of the present disclosure or the technical solutions in the prior art, the following will briefly introduce the drawings required in the description of the specific embodiments or the prior art. Obviously, the drawings described below are some embodiments of the present disclosure, and those of ordinary skills in the art can also obtain other drawings based on these drawings without creative efforts.

FIG. 1 is a schematic flow diagram of an audio synthesis method provided according to an embodiment of the present disclosure;

FIG. 2 is a schematic flow diagram of another audio synthesis method provided according to an embodiment of the present disclosure;

FIG. 3 is a schematic flow diagram of yet another audio synthesis method provided according to an embodiment of the present disclosure;

FIG. 4 is a schematic flow diagram of still yet another audio synthesis method provided according to an embodiment of the present disclosure;

FIG. 5 is a schematic flow diagram of still yet another audio synthesis method provided according to an embodiment of the present disclosure;

FIG. 6 is a schematic flow diagram of still yet another audio synthesis method provided according to an embodiment of the present disclosure;

FIG. 7 is a block diagram of a structure of an audio synthesis apparatus according to an embodiment of the present disclosure; and

FIG. 8 is a schematic diagram of a hardware structure of an electronic device according to an embodiment of the present disclosure.

### DETAILED DESCRIPTION

To make the objectives, technical solutions, and advantages of the embodiments of the present disclosure more clear, the following will clearly and completely describe the technical solutions in the embodiments of the present disclosure in conjunction with the drawings in the embodiments of the present disclosure. Obviously, the described embodiments are some, rather than all, of the embodiments of the present disclosure. Based on the embodiments of the present disclosure, all other embodiments obtained by those skilled in the art without creative efforts shall fall within the protection scope of the present disclosure.

In the related art, in order to mix and synthesize human voice with accompaniment, a professional audio engineer is required to perform manual synthesis by utilizing a system and software involving digital signal processing (DSP), and the skills and experience of the audio engineer are highly relied on, so that the professional restrictions on synthesis are tight.

Moreover, human voice synthesized by a machine lacks subtle details in real human voice, which leads to the fact that the audio engineer is also required to spend a lot of time in perform targeted adjustment in a synthesis process to achieve desired voice, and then leads to low efficiency of synthesis.

In view of this, an example of the present disclosure provides an audio synthesis method which can adjust a second loudness range of second human voice audio corresponding to reference audio by taking a first loudness range as a benchmark after specifying the first loudness range of first human voice audio in the reference audio, so that loudness of first target human voice audio obtained can be aligned with the loudness of the first human voice audio, and then the first target human voice audio is utilized for being mixed with accompaniment audio in the reference audio, which can not only enable the synthesis process of the audio to be more convenient and efficient, but also effectively enhance the sound quality of the synthesized target audio and improve the synthesis efficiency of the audio.

According to the example of the present disclosure, an example of the audio synthesis method is provided. It should be noted that the steps shown in the flowchart of the accompanying drawings may be executed in a computer system, such as a set of computer-executable instructions, and although a logical order is shown in the flowchart, in some cases, the shown or described steps may be executed in an order other than that herein.

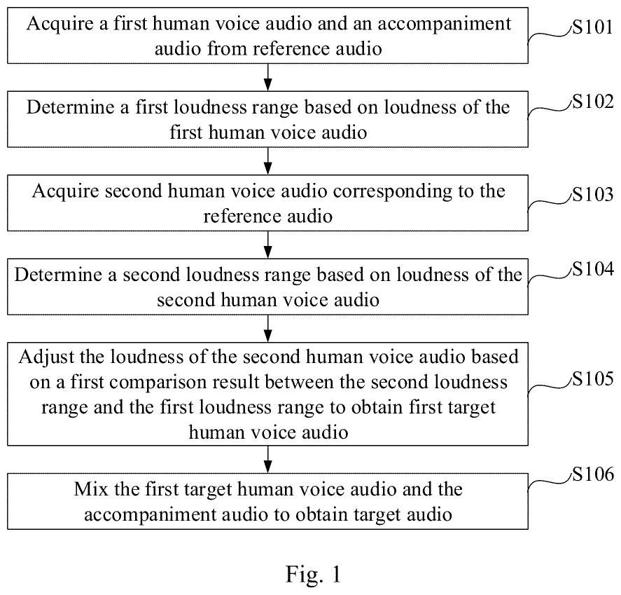

In this example, an audio synthesis method is provided, which may be used for an electronic device, such as a mobile phone, and a tablet computer. FIG. 1 is a flowchart of the audio synthesis method according to the example of the present disclosure, and as shown in FIG. 1, the flow includes the following steps.

Step S101, first human voice audio and accompaniment audio in reference audio are acquired.

The reference audio refers to a reference standard used for performing audio synthesis, including human voice and background music (BGM). The reference audio may be complete audio, and may also be an audio clip in the specified audio, which may be specifically determined according to requirements, wherein first human voice audio refers to audio corresponding to the human voice in the reference audio, and accompaniment audio refers to audio corresponding to the background music in the reference audio. The human voice corresponding to the first human voice audio may be real human voice. In some optional instances, the first human voice audio and the accompaniment audio may be obtained by a way of performing music source separation (MSS) processing on the reference audio.

Step S102, a first loudness range is determined based on loudness of the first human voice audio.

In order to facilitate the specification of a processing benchmark for human voice during subsequent audio synthesis, the loudness range of the first human voice audio is specified based on the loudness of the first human voice audio, so that when second human voice audio is subsequently processed, there may be a clear reference basis, thereby better achieving audio effect matching subsequently.

In some optional implementation scenes, a determination process of the first loudness range may be as follows: firstly overall audio energy of the first human voice audio is detected, and then processed by utilizing a specified loudness calculation formula to obtain average loudness of the first human voice audio. For example, the average loudness of the first human voice audio may be determined by utilizing a standardized loudness calculation formula, and a relevant formula is as follows:

$${L}_{avg} = \frac{1}{T} {\int }_{0}^{T} L ( t ) dt$$

wherein L(t) refers to instantaneous loudness at a sampling time t, T refers to a total duration of the first human voice audio, and L_{avg} refers to the average loudness of the first human voice audio.

The first human voice audio is sampled and quantized, and then the first human voice audio is converted into a time-domain signal through inverse transform processing of Fourier transform, so as to specify a signal amplitude variation of the first human voice audio at each sampling time.

In order to improve the accuracy of the first loudness range, a maximum loudness value and a minimum loudness value of the first human voice audio at each sampling time are respectively determined, and then a sub-first loudness range DR corresponding to each sampling time is obtained, wherein the maximum loudness value may be represented by Lₚₑₐₖ=max(|x(t)|), the minimum loudness value may be represented by Lₘᵢₙ=min(|x(t)|), and x(t) represents a signal amplitude of the first human voice audio at a corresponding sampling time. An expression for the sub-first loudness range DR corresponding to each sampling time may be (Lₘᵢₙ, Lₚₑₐₖ).

The loudness ranges of the first human voice audio at different sampling times may be specified by the sub-first loudness range corresponding to each sampling time, and then an overall dynamic loudness range of the first human voice audio is obtained, that is, the first loudness range of the first human voice audio is obtained.

Step S103, second human voice audio corresponding to the reference audio is acquired.

The second human voice audio refers to human voice audio to be used for audio synthesis, wherein human voice corresponding to the second human voice audio may be real human voice, and may also be synthesized by a machine, which may be specifically determined according to requirements.

Step S104, a second loudness range is determined based on loudness of the second human voice audio.

In order to facilitate the targeted adjustment of the second human voice audio and improve the audio quality, the loudness of the second human voice audio is processed to specify the overall loudness range of the second human voice audio and determine the second loudness range.

In some optional instances, when the loudness of the second human voice audio is processed, the processing is performed in the same analytical way as the loudness of the first human voice audio, so as to ensure that the two are based on the same standards, so that the loudness of the two audio has consistency and comparability based on the results, and errors can be reduced when subsequent adjustment is performed.

Step S105, the loudness of the second human voice audio is adjusted based on a first comparison result between the second loudness range and the first loudness range to obtain first target human voice audio.

By comparing the second loudness range with the first loudness range, a difference between the second loudness range and the first loudness range can be specified, and then the first comparison result can be obtained.

Since the first loudness range and the second loudness range are both ranges which dynamically change at random time, in order to enable the loudness of the second human voice audio to better match the loudness of the first human voice audio in the reference audio, the loudness of the second human voice audio is adjusted based on the first comparison result, so as to enable the loudness of the first target human voice audio obtained to better conform to a loudness feature of the first human voice audio, and then be helpful in improving the overall consistency and harmony of the target audio when the audio synthesis is subsequently performed.

Step S106, the first target human voice audio and the accompaniment audio are mixed to obtain target audio.

The first target human voice audio subjected to loudness adjustment is mixed with the accompaniment audio, so that the human voice in the first target human voice audio can match the background music in the reference audio, so as to obtain the target audio corresponding to the human voice in the second human voice audio.

According to the audio synthesis method provided in this example, the targeted adjustment can be performed on the loudness of the second human voice audio by taking the first loudness range of the first human voice audio in the reference audio as a benchmark in a way of matching the loudness ranges, thereby not only simplifying the synthesis process of the audio and enabling the synthesis process of the target audio to be more convenient and efficient, but also effectively enhancing the sound quality of the synthesized target audio and effectively improving the synthesis efficiency of the audio.

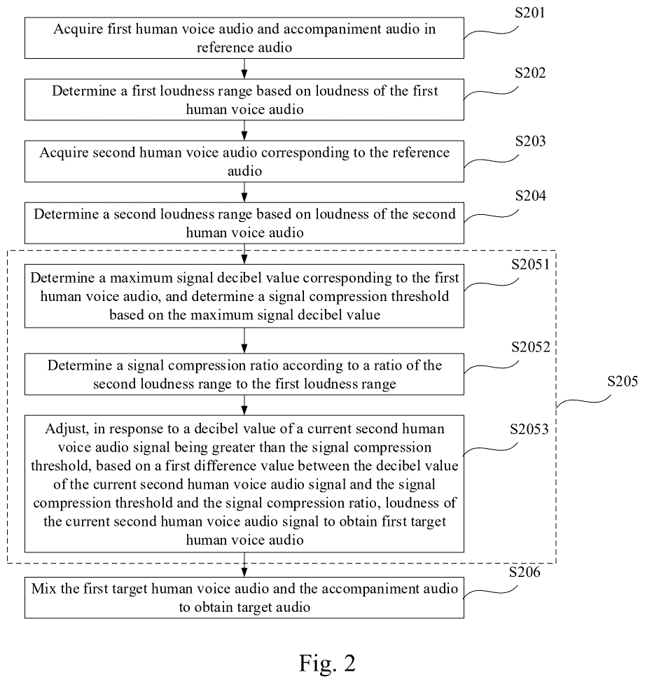

In this example, an audio synthesis method is provided, which may be used for an electronic device, such as a mobile phone, and a tablet computer. FIG. 2 is a flowchart of the audio synthesis method according to the example of the present disclosure, and as shown in FIG. 2, the flow includes the following steps.

Step S201, first human voice audio and accompaniment audio in reference audio are acquired. Reference may be made to step S101 of the example shown in FIG. 1 for details, which will not be described in detail herein.

Step S202, a first loudness range is determined based on loudness of the first human voice audio. Reference may be made to step S102 of the example shown in FIG. 1 for details, which will not be described in detail herein.

Step S203, second human voice audio corresponding to the reference audio is acquired. Reference may be made to step S103 of the example shown in FIG. 1 for details, which will not be described in detail herein.

Step S204, a second loudness range is determined based on loudness of the second human voice audio. Reference may be made to step S104 of the example shown in FIG. 1 for details, which will not be described in detail herein.

Step S205, the loudness of the second human voice audio is adjusted based on a first comparison result between the second loudness range and the first loudness range to obtain first target human voice audio.

The audio synthesis method provided in the embodiment may adjust the loudness of the second human voice audio in a targeted manner by matching the loudness range, using the first loudness range of the first human voice audio in the reference audio as a benchmark. This not only simplifies the audio synthesis process, making the synthesis of the target audio more convenient and efficient, but also effectively improves the sound quality of the synthesized target audio, thereby significantly enhancing the efficiency of audio synthesis.

Specifically, the above step S205 includes:
step S2051, a maximum signal decibel value corresponding to the first human voice audio is determined, and a signal compression threshold is determined based on the maximum signal decibel value.

In order to enable the loudness of the second human voice audio to be more uniform and reasonably adjust the loudness of the second human voice audio, the maximum signal decibel value corresponding to the first human voice audio is determined, so as to specify an upper limit of the loudness of the first human voice audio, and then the signal compression threshold is determined based on the maximum signal decibel value, so as to avoid distortion or other adverse effects in the subsequent adjustment, and ensure the integrity and accuracy of a second human voice audio signal.

For example, a conversion formula between the decibel value and the loudness is as follows:

$${L}_{p} = 20 lg ( \frac{p}{{p}_{0}} ) ;$$

wherein Lₚ represents a sound pressure level in a unit of decibel, p represents sound pressure to be measured in a unit of pascal, and po is reference sound pressure which is generally taken as 2×10⁵ pascals in air.

It can be seen from the above formula that there is a 20-fold relationship in the conversion between the decibel value and the loudness. Therefore, in order to enable the compression to have higher reasonability, when the signal compression threshold is determined, a difference value between the maximum signal decibel value and 20 may be taken as the signal compression threshold, so that the signal compression threshold may be utilized as a restriction on signal compression subsequently to ensure the reasonability of the compression.

Step S2052, a signal compression ratio is determined according to a ratio of the second loudness range to the first loudness range.

Wherein the signal compression ratio is used for reflecting a relative relationship between the loudness range of the second human voice audio and the loudness range of the first human voice audio. An expression for the signal compression ratio (ratio) is as follows:

$$ratio = \frac{Second loudness range}{First loudness range} .$$

By determining the signal compression ratio, it is possible to maintain relative balance between the loudness of the second human voice audio and the loudness of the first human voice audio to some extent as much as possible in the process of compressing the second human voice audio, thereby avoiding the occurrence of the situation that the loudness is too high or too low, and being helpful in improving the overall quality of the second human voice audio.

Since the first loudness range is a set of sub-first loudness ranges corresponding to a plurality of sampling times, and the second loudness range is a set of sub-second loudness ranges corresponding to a plurality of sampling times, the signal compression ratio is also a set of sub-signal compression ratios corresponding to a plurality of sampling times, and thus the adjustment may be ensured to be targeted and reliable.

Step S2053, in response to a decibel value of a current second human voice audio signal being greater than the signal compression threshold, based on a first difference value between the decibel value of the current second human voice audio signal and the signal compression threshold and the signal compression ratio, loudness of the current second human voice audio signal is adjusted to obtain first target human voice audio.

Wherein the current second human voice audio signal is one of audio signals in the second human voice audio. In the process of adjusting the loudness of the second human voice audio, whether the decibel value of the current second human voice audio signal at the current sampling time is greater than the signal compression threshold is detected by means of segment-by-segment matching. In response to the decibel value of the current second human voice audio signal being greater than the signal compression threshold, the loudness of the second human voice audio is characterized as being too high, and compression processing is required to be performed on the second human voice audio. Therefore, based on the first difference value between the decibel value of the current second human voice audio signal and the signal compression threshold and the signal compression ratio, the loudness of the current second human voice audio signal is appropriately compressed to enhance the audibility of the second human voice audio, so as to finally obtain the first target human voice audio.

In some optional implementation scenes, a formula for signal adjustment may be as follows:

$$y ( t ) = x ( t ) \times {( \frac{1}{ratio} )}^{( {x}_{dB} ( t ) - threshold ) / 20} ,$$

wherein y(t) is the current second human voice audio signal adjusted at the current sampling time, x(t) is the current second human voice audio signal input at the current sampling time, ratio is the signal compression ratio at the current sampling time, x_{dB}(t) is the decibel value of the current second human voice audio signal at the current sampling time, and threshold is the signal compression threshold at the current sampling time.

By compressing the current second human voice audio signal through the above formula for signal adjustment, the manner of loudness adjustment may be more reasonable, and the adjusted first target human voice audio has more harmonious loudness and higher audibility without loss of the sound quality.

In some optional embodiments, in response to the decibel value of the current second human voice audio signal being less than or equal to the signal compression threshold, loudness adjustment processing is not performed on the current second human voice audio signal. That is, in response to the decibel value of the current second human voice audio signal being less than or equal to the signal compression threshold, the loudness of the current second human voice audio signal is characterized as being reasonable, and therefore, the loudness adjustment processing is not performed on the current second human voice audio signal, so as to avoid the occurrence of situations such as loss of sound quality or signal distortion due to unnecessary adjustment, thereby being helpful in saving calculation resources and improving the processing efficiency.

In some optional implementation scenes, a formula for adjustment of the loudness of the second human voice audio signal may be as follows:

$$y ( t ) = \{ \begin{matrix}x ( t ) \times {( \frac{1}{ratio} )}^{( {x}_{dB} ( t ) - threshold ) / 20} , & {x}_{dB} ( t ) > threshold \\ x ( t ) , & {x}_{dB} ( t ) \leq threshold\end{matrix} ,$$

and then timeliness of the adjustment of the audio signal may be ensured.

Step S206, the first target human voice audio and the accompaniment audio are mixed to obtain target audio. Reference may be made to step S106 of the example shown in FIG. 1 for details, which will not be described in detail herein.

In the audio synthesis method provided in this example, in the process of adjusting the loudness of the second human voice audio, by performing the targeted adjustment through the determined signal compression threshold and signal compression ratio, it is possible to maintain relative balance between the loudness of the second human voice audio and the loudness of the first human voice audio to some extent, thereby avoiding the occurrence of the situation that the volume is too high or too low, and then effectively improving the quality and audibility of the audio, which is beneficial to improving the auditory experience of a user.

In some optional implementation scenes, extension processing may be performed on the audio signal with too low loudness in the second human voice audio signal to enhance the dynamics of the music.

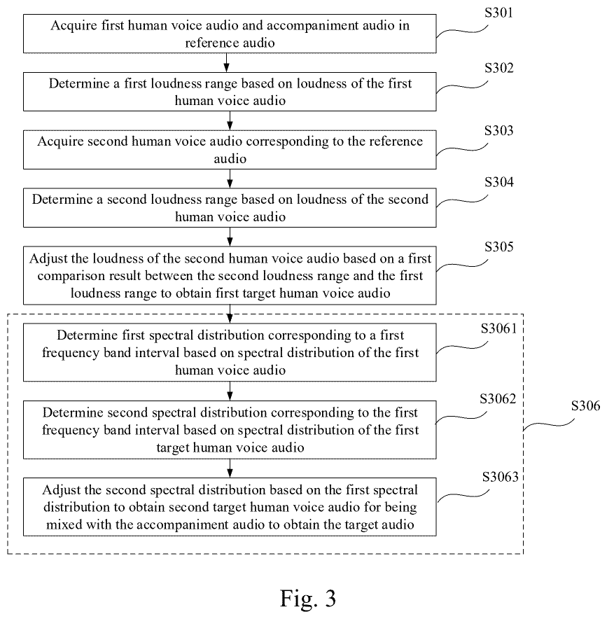

In this example, an audio synthesis method is provided, which may be used for an electronic device, such as a mobile phone, and a tablet computer. FIG. 3 is a flowchart of the audio synthesis method according to the example of the present disclosure, and as shown in FIG. 3, the flow includes the following steps.

Step S301, first human voice audio and accompaniment audio in reference audio are acquired.

Step S302, a first loudness range is determined based on loudness of the first human voice audio.

Step S303, second human voice audio corresponding to the reference audio is acquired.

Step S304, a second loudness range is determined based on loudness of the second human voice audio.

Step S305, the loudness of the second human voice audio is adjusted based on a first comparison result between the second loudness range and the first loudness range to obtain first target human voice audio.

Step S306, the first target human voice audio and the accompaniment audio are mixed to obtain target audio.

Specifically, the above step S306 includes:
step S3061, first spectral distribution corresponding to a first frequency band interval is determined based on spectral distribution of the first human voice audio.

In order to enhance the naturalness of the second human voice audio, spectral-based processing is performed on the first human voice audio to determine the spectral distribution of the first human voice audio, and then specify the first spectral distribution of the first human voice audio in a first frequency range, so as to reflect the situation of energy distribution of the first human voice audio in the first frequency range through the first spectral distribution.

Wherein the first frequency band interval may be understood as a frequency band interval which requires targeted adjustment. For example, the first frequency band interval may be a low frequency band interval (about 20 Hz to 250 Hz), a medium frequency band interval (about 250 Hz to 2 kHz), or a high frequency band interval (about 2 kHz to 5 kHz and above), wherein the low frequency band interval mainly contains fundamental-frequency and low-frequency harmonic waves of sound, which are used for reflecting the feeling of fullness and strength of the sound; the medium frequency band interval mainly contains resonance peaks of the sound, which are used for forming features and intelligibility of the sound; and the high frequency band interval mainly contains sharpness and clarity of the sound, which are used for reflecting the clarity and details of the sound. Preferably, the first frequency band interval may be the high frequency band interval, thereby being helpful in enriching the sound details of the second human voice audio during the subsequent adjustment of the second human voice audio.

In some optional implementation scenes, the overall spectral distribution of the first human voice audio may be determined by performing Fourier transform processing on the first human voice audio, and then the first spectral distribution may be determined based on a frequency range corresponding to the first frequency band interval, wherein a relevant formula for performing the Fourier transform processing is as follows:

$$S ( f ) = \int x ( t ) {e}^{- j 2 π ft} dt ;$$

wherein x(t) is an audio signal of the first human voice audio in a current sampling time, and S(f) is a spectral amplitude value at a frequency f.

Step S3062, second spectral distribution corresponding to the first frequency band interval is determined based on spectral distribution of the first target human voice audio.

The same analysis processing is performed on the spectral distribution of the first target human voice audio, so as to determine the second spectral distribution corresponding to the first frequency band interval in the overall spectral distribution of the first target human voice audio.

Step S3063, the second spectral distribution is adjusted based on the first spectral distribution to obtain second target human voice audio for being mixed with the accompaniment audio to obtain the target audio.

In order to enable the target audio obtained after mixing to be more balanced in the frequency, for the same first frequency band interval, the first spectral distribution of the first human voice audio is utilized for adjusting the second spectral distribution of the first target human voice audio, so that the frequency of the adjusted second target human voice audio may better match the frequency of the first human voice audio, thereby being helpful in enhancing the fusion of the second target human voice audio and the accompaniment audio, and enabling the subsequently obtained target audio to sound more natural and harmonious, which is beneficial to improving the overall quality of the target audio.

In some optional embodiments, the above step S3063 includes:
step a1, a first spectral initial value of the first spectral distribution is determined.

In order to enable the frequency of the second target human voice audio in the first frequency band interval to be more prominent, a first spectral initial point of the first spectral distribution is determined to be taken as a benchmark, and then the expressive force and characteristics of the human voice can be enhanced during subsequent enhancement adjustment.

Step a2, in response to a current second spectral value being greater than the first spectral initial value, a second difference value between the current second spectral value and the first spectral initial value is determined.

Wherein the current second spectral value is one of spectral values in the second spectral distribution. In the process of adjusting the second spectral distribution, in response to the current second spectral value being greater than the first spectral initial value, targeted enhancement processing is characterized as being required to be performed on the current second spectral value, and therefore, the second difference value between the current second spectral value and the first spectral initial value is determined to specify the difference between the two.

Step s3, the current second spectral value is adjusted based on the second difference value and a specified enhancement factor to obtain third spectral distribution.

In order to enhance the contrast of the spectral distribution and enable the second target human voice audio to be more clear and discernible when being mixed with the accompaniment audio, the targeted adjustment is performed on the current second spectral value by utilizing the second difference value and the specified enhancement factor, so that the frequencies of the second target human voice audio in the first frequency band interval have richer levels, thereby achieving the purpose of improving the overall quality of the second human voice audio, wherein the third spectral distribution means that after the second spectral distribution is adjusted, the second target human voice audio corresponds to the adjusted overall spectral distribution. The above process may be represented by the following formula:

Y(f)=X(f)+α(X(f)−T(f)); wherein f refers to the second spectral value greater than the first spectral initial value, X(f) refers to the first spectral distribution, T(f) refers to the second spectral distribution, and α refers to the enhancement factor, and wherein the enhancement factor may be determined based on frequency domain energy corresponding to the first spectral distribution, thereby ensuring the reasonability of the spectral enhancement. For example, in response to the first frequency band interval being the high frequency band interval, the enhancement factor may have a range of values between 30% and 50% of the frequency domain energy corresponding to the first spectral distribution. That is, the frequency domain energy of the first spectral distribution is 100, and then the enhancement factor may have a value between 30 (30% of 100) and 50 (50% of 100). In this way, when the second spectral distribution is subsequently adjusted according to the enhancement factor, the targeted adjustment may be performed with reference to the situation of the frequency domain energy of the first spectral distribution, thereby being helpful in maintaining the relative balance and reasonability of the audio in the adjustment process.

In some optional instances, in response to the current second spectral value being less than or equal to the first spectral initial value, the current second spectral value is not adjusted, thereby being helpful in improving the adjustment efficiency.

Step a4, the second target human voice audio is obtained based on the third spectral distribution.

In some optional instances, the above step a4 includes:
step a31, target harmonic energy is determined based on first harmonic spectral distribution of the first human voice audio;
step a32, second harmonic spectral distribution in the third spectral distribution is determined;
step a33, a harmonic adjustment order is determined based on the target harmonic energy; and
step a34, the second harmonic spectral distribution is adjusted based on the harmonic adjustment order and a specified adjustment factor to obtain the second target human voice audio.

Specifically, in order to enable the second target human voice audio to be fuller and livelier, a harmonic spectral of the first human voice audio is processed to determine the situation of energy distribution of each harmonic component in the first human voice audio based on the first harmonic spectral distribution of the first human voice audio, and then determine the target harmonic energy. The target harmonic energy is set based on the desire for the audio effect and the features of the first human voice audio for the harmonic energy level desired to be achieved in the second target human voice audio.

In order to further accurately adjust and optimize the harmonic part, the harmonic adjustment order is determined according to the target harmonic energy, wherein the harmonic adjustment order determines the fineness and range of the adjustment of the second harmonic spectral distribution.

In order to ensure the reasonability of harmonic adjustment, the specified adjustment factor is determined based on the frequency domain energy corresponding to the first spectral distribution, so as to control the strength and amplitude of the adjustment, and then targeted adjustment may be performed on the second harmonic spectral distribution based on the harmonic adjustment order and the specified adjustment factor through the following formula:

H(f)=βS(nf), wherein n refers to the harmonic order, n=2, 3, 4 (the specific value may be determined according to actual requirements), β refers to the specified adjustment factor; S(f) refers to the second harmonic spectral distribution, and H(f) refers to the adjusted second harmonic spectral distribution.

Preferably, the specified adjustment factor may have a range of values between 0% and 3% of the frequency domain energy corresponding to the first spectral distribution, thereby being helpful in enabling the harmonic characteristic of the second target human voice audio to better meet expectation, and optimizing the timbre and sound quality of the audio to enable the audio to sound more natural and comfortable.

By adjusting the second harmonic spectral distribution in the above manner, the harmonic consistency between the second target human voice audio and the first human voice audio may be enhanced, thereby being helpful in improving the overall harmony and coherence of the audio.

In some optional instances, the above step a4 further includes:
step a44, first phase distribution is obtained based on a spectral phase of the first spectral distribution;
step a45, second phase distribution corresponding to the first frequency band interval and third phase distribution corresponding to a second frequency band interval are obtained based on a spectral phase of the third spectral distribution, a frequency value in the second frequency band interval being less than a frequency value in the first frequency band interval; and
step a46, the second phase distribution is adjusted based on the first phase distribution and the third phase distribution to obtain the second target human voice audio.

Specifically, in order to improve the transparency and the performance of details of the audio, targeted analysis is performed on the spectral phase of the first spectral distribution to specify the situation of phase distribution of the first spectral distribution, so as to obtain the first phase distribution.

Since the spectral distribution of the third spectral distribution means that after the second spectral distribution is adjusted, the second target human voice audio corresponds to the adjusted overall spectral distribution, in order to reasonably improve the sound quality of the second human voice audio, the targeted analysis is performed on the spectral phase of the third spectral distribution, so as to obtain the second phase distribution corresponding to the first frequency band interval and the third phase distribution corresponding to the second frequency band interval, wherein the frequency value in the second frequency band interval is less than the frequency value in the first frequency band interval.

A phase distribution benchmark for the second human voice audio may be specified by the third phase distribution, and then when the second phase distribution is adjusted based on the first phase distribution and the third phase distribution, the occurrence of the situation of excessive adjustment may be avoided, so as to obtain the second target human voice audio meeting expectation.

For example, the process of adjusting the second phase distribution may be represented by the following formula:

$${ϕ}_{new} ( f ) = {ϕ}_{orig} ( f ) + δϕ ( f ) ;$$

wherein ϕ_{orig}(f) refers to the second phase distribution, ϕ_{new}(f) refers to the adjusted second phase distribution, and δ is determined based on the first phase distribution and the third phase distribution. For example, the first phase distribution is a phase of the first human voice audio in the high frequency band interval, the third phase distribution is a phase of the second human voice audio in the medium frequency band interval, and then δ is set to be between the first phase distribution of 5% and the third phase distribution of 10%, thereby being helpful in improving the sound quality, the clarity, the degree of balance, and the like of the second human voice audio.

The audio synthesis method provided in this example can effectively improve the quality and fusion of the target audio through the spectral analysis and adjustment of the human voice audio, thereby being helpful in ensuring the fullness and naturalness of the target audio in the spectral.

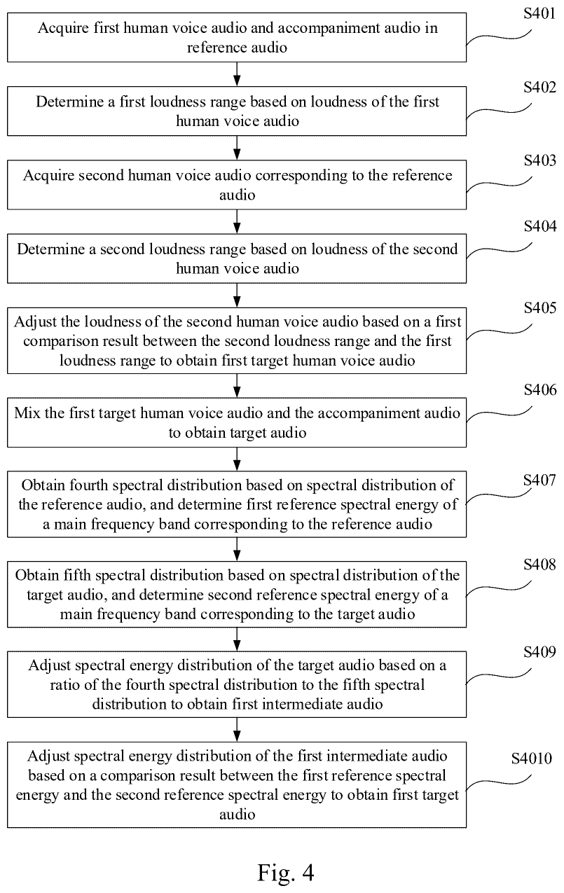

In this example, an audio synthesis method is provided, which may be used for an electronic device, such as a mobile phone, and a tablet computer. FIG. 4 is a flowchart of the audio synthesis method according to the example of the present disclosure, and as shown in FIG. 4, the flow includes the following steps.

Step S401, first human voice audio and accompaniment audio in reference audio are acquired.

Step S402, a first loudness range is determined based on loudness of the first human voice audio.

Step S403, second human voice audio corresponding to the reference audio is acquired.

Step S404, a second loudness range is determined based on loudness of the second human voice audio.

Step S405, the loudness of the second human voice audio is adjusted based on a first comparison result between the second loudness range and the first loudness range to obtain first target human voice audio.

Step S406, the first target human voice audio and the accompaniment audio are mixed to obtain target audio.

Step S407, fourth spectral distribution is obtained based on spectral distribution of the reference audio, and first reference spectral energy of a main frequency band corresponding to the reference audio is determined.

In order to maintain a spectral of the target audio and a spectral of the reference audio to be consistent and harmonious, the situation of the distribution of frequency components of the reference audio is understood based on the situation of the overall spectral distribution of the reference audio, and then the fourth spectral distribution is obtained.

The main frequency band refers to a frequency range in which the energy is relatively concentrated in the audio. By determining the first reference spectral energy of the main frequency band corresponding to the reference audio, it is helpful in performing the targeted comparison and adjustment subsequently.

Step S408, fifth spectral distribution is obtained based on spectral distribution of the target audio, and second reference spectral energy of a main frequency band corresponding to the target audio is determined.

By the same reasoning, the situation of the distribution of frequency components of the target audio is understood based on the situation of the overall spectral distribution of the target audio, and then the fifth spectral distribution is obtained. The fifth spectral distribution reflects the energy distribution of the target audio at each frequency.

In order to enable the adjustment to be more targeted, the second reference spectral energy of the main frequency band corresponding to the target audio is determined to specify the situation of the spectral distribution of the main frequency band in the target audio.

Step S409, spectral energy distribution of the target audio is adjusted based on a ratio of the fourth spectral distribution to the fifth spectral distribution to obtain first intermediate audio.

By comparing the fourth spectral distribution and the fifth spectral distribution, an energy difference between the two in the frequency may be understood, and then an energy relative relationship between the reference audio and the target audio at each frequency may be specified according to the ratio of the two. Based on this ratio, the spectral energy distribution of the target audio is adjusted, so that the spectral energy distribution of the first intermediate audio obtained is closer to a spectral characteristic of the reference audio than the original target audio, thereby being helpful in improving the sound quality of the target audio, and enabling the energy distribution of the target audio in the frequency to be more reasonable.

For example, the process of adjusting the spectral energy distribution of the target audio based on the ratio of the fourth spectral distribution to the fifth spectral distribution may be represented by the following formula:

$$Y ( f ) = X ( f ) \times \frac{{S}_{ref} ( f )}{{S}_{orig} ( f )} ,$$

wherein X(f) is the spectral of the target audio, S_{orig}(f) is the fifth spectral distribution, S_{ref}(f) is the fourth spectral distribution, and Y(f) is a spectral of the first intermediate audio.

Step S4010, spectral energy distribution of the first intermediate audio is adjusted based on a comparison result between the first reference spectral energy and the second reference spectral energy to obtain first target audio.

The spectral energy distribution of the first intermediate audio is further adjusted according to the comparison result. In response to the first reference spectral energy being greater than the second reference spectral energy, the energy of the first intermediate audio on the main frequency band is increased; conversely, in response to the first reference spectral energy being less than the second reference spectral energy, the energy of the first intermediate audio on the main frequency band is decreased, so that the obtained first target audio is closer to the reference audio in the spectral energy distribution.

In some optional implementation scenes, the process of adjusting the spectral energy distribution of the first intermediate audio may be represented by the following formula:

$$Y ' ( f ) = \{ \begin{matrix}Y ( f ) \times gain factor , & f ∈ main frequency band \\ Y ( f ) , & others\end{matrix} ,$$

wherein gain factor is a gain factor determined based on a difference value between the first reference spectral energy and the second reference spectral energy.

The audio synthesis method provided in this example may enable the finally synthesized first target audio to be closer to the reference audio by performing spectral processing and dynamic range optimization on the second human voice audio, thereby effectively improving the quality and consistency of the synthesized audio.

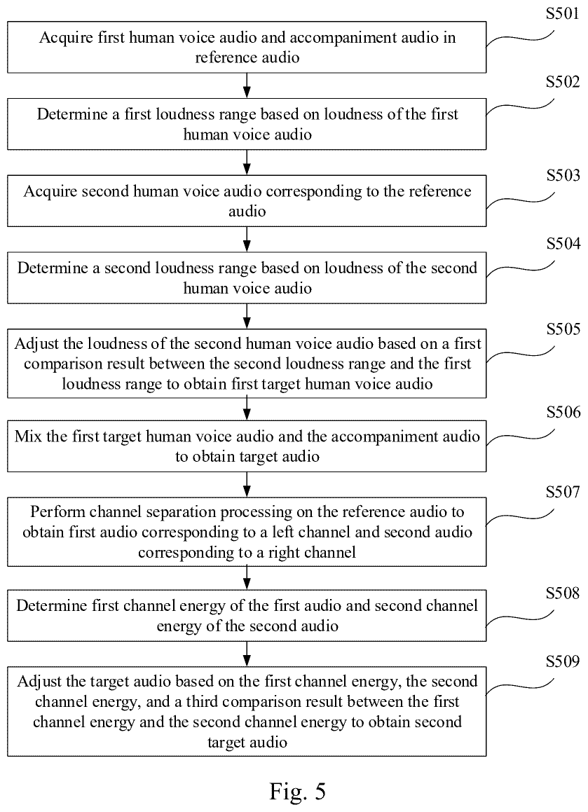

In this example, an audio synthesis method is provided, which may be used for an electronic device, such as a mobile phone, and a tablet computer. FIG. 5 is a flowchart of the audio synthesis method according to the example of the present disclosure, and as shown in FIG. 5, the flow includes the following steps.

Step S501, first human voice audio and accompaniment audio in reference audio are acquired.

Step S502, a first loudness range is determined based on loudness of the first human voice audio.

Step S503, second human voice audio corresponding to the reference audio is acquired.

Step S504, a second loudness range is determined based on loudness of the second human voice audio.

Step S505, the loudness of the second human voice audio is adjusted based on a first comparison result between the second loudness range and the first loudness range to obtain first target human voice audio.

Step S506, the first target human voice audio and the accompaniment audio are mixed to obtain target audio.

Step S507, channel separation processing is performed on the reference audio to obtain first audio corresponding to a left channel and second audio corresponding to a right channel.

In order to enable a stereophonic feature of the target audio to be consistent with a stereophonic feature of the reference audio, the channel separation processing is performed on the reference audio, then the first audio corresponding to the left channel and the second audio corresponding to the right channel are obtained, and then the subsequent processing is performed in separate channels, thereby being helpful in improving the accuracy of analysis and adjustment.

Step S508, first channel energy of the first audio and second channel energy of the second audio are determined.

Wherein an expression for the first channel energy is as follows: E_{left}=Σₙ|S_{left}[n]|², and S_{left}[n] refers to the first audio. An expression for the second channel energy is as follows: E_{right}=Σₙ|S_{right}[n]|², and S_{right}[n] refers to the second audio.

Step S509, the target audio is adjusted based on the first channel energy, the second channel energy, and a third comparison result between the first channel energy and the second channel energy to obtain second target audio.

An energy difference between the left channel and the right channel in the reference audio may be specified according to the third comparison result between the first channel energy and the second channel energy, and then when the subsequent target adjustment is performed on the target audio by utilizing the first channel energy and the second channel energy, the channel energy may be equalized, so as to obtain the second target audio which is closer to the reference audio.

In some optional embodiments, the above step S509 includes:
step c1, channel separation processing is performed on the target audio to obtain third audio corresponding to the left channel and fourth audio corresponding to the right channel;
step c2, first target gain corresponding to the left channel is determined based on the third comparison result and a ratio of the first channel energy to the second channel energy;
step c3, second target gain corresponding to the right channel is determined based on the third comparison result and a ratio of the second channel energy to the first channel energy; and
step c4, the third audio is adjusted by the first target gain and the fourth audio is adjusted by the second target gain respectively to obtain second target audio.

Specifically, the channel separation processing is performed on the target audio to obtain the third audio corresponding to the left channel and the fourth audio corresponding to the right channel in the target audio.

An energy intensity relationship between the left channel and the right channel in the reference audio may be specified according to the third comparison result, and then when the first target gain corresponding to the left channel and the second target gain corresponding to the right channel are determined, whether an adjustment type of the gain is increasing or decreasing may be specified. For example, in response to the third comparison result characterizing that the first channel energy is greater than the second channel energy, the gain of the right channel requires to be increased, and the gain of the left channel requires to be decreased. In response to the third comparison result characterizing that the first channel energy is less than the second channel energy, the gain of the left channel requires to be increased, and the gain of the right channel requires to be decreased.

A gain numerical value of the first target gain corresponding to the left channel may be obtained according to the ratio of the first channel energy to the second channel energy, and then whether a symbol of the gain numerical value is “+” or “−” may be determined according to the third comparison result, so as to obtain the first target gain. By the same reasoning, a gain numerical value of the second target gain corresponding to the right channel may be obtained according to the ratio of the second channel energy to the first channel energy, and then whether a symbol of the gain numerical value is “+” or “−” may be determined according to the third comparison result, so as to obtain the second target gain.

The third audio is adjusted by the first target gain and the fourth audio is adjusted by the second target gain respectively, so as to balance the outputs of the left channel and the right channel of the target audio, and then obtain the second target audio.

In some optional instances, the above step c4 includes:
step c41, the third audio is adjusted using the first target gain to obtain fifth audio;
step c42, the fourth audio is adjusted using the second target gain to obtain sixth audio;
step c43, a cross-correlation relationship between the first audio and the second audio is determined; and
step c44, a time difference between the fifth audio and the sixth audio is adjusted based on the cross-correlation relationship to obtain the second target audio.

Specifically, in order to reduce a time delay or a phase difference between the left channel and the right channel, the third audio is adjusted by the first target gain to obtain the fifth audio and the fourth audio is adjusted by the second target gain to obtain the sixth audio respectively, so as to obtain the fifth audio corresponding to the left channel and the sixth audio corresponding to the right channel of the target audio after being adjusted.

Wherein a determination process of the fifth audio is as follows: _Y_{left}[n]=X_{left}[n]×gain_{left}, wherein X_{left}[n] represents the third audio, and gain_{left} is the first target gain. A determination process of the sixth audio is as follows: _Y_{right}[n]=X_{right}[n]×gain_{right}, wherein X_{right}[n] represents the fourth audio, and gain_{right} is the second target gain.

In order to simulate a stereophonic width of the reference audio, the cross-correlation relationship between the first audio and the second audio is determined, and then the time difference between the fifth audio and the sixth audio is adjusted, so that the most suitable delay value may be found therefrom, and the second target audio is obtained, so as to be closer to the stereophonic width of the reference audio.

A formula adopted for adjusting the time difference between the fifth audio and the sixth audio may be as follows:
Y_{right}[n]=Y_{left}[n−τₒₚₜ]×e^{jφ}^{ₒₚₜ}; wherein τₒₚₜ refers to an optimal sample delay, that is, a maximum delay value in a cross-correlation function R[k].
R[K]=ΣₙS_{left}[n]×S_{right}[n+k], wherein k is the maximum delay value to be determined.

The audio synthesis method provided in this example may effectively improve the quality of the overall spatial sense and hearing sense while ensuring that the stereophonic characteristic of the synthesized second target audio is consistent with the stereophonic characteristic of the reference audio, thereby effectively improving the quality of audio synthesis.

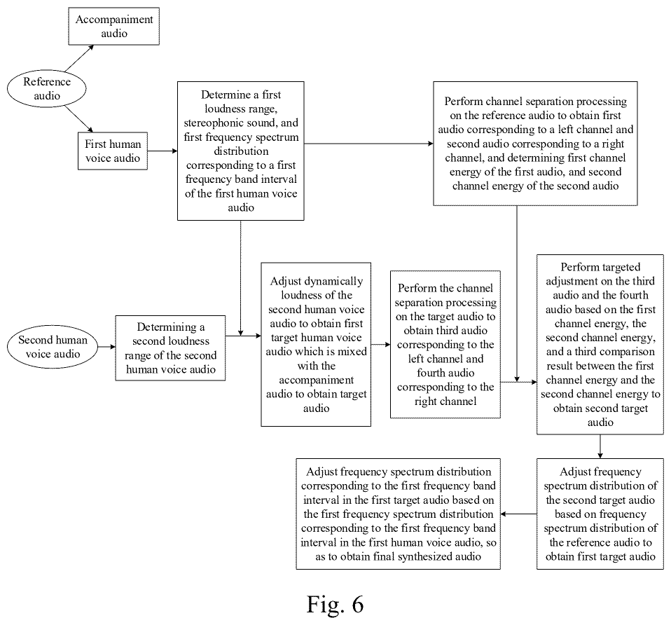

As one or more specific application examples of the examples of the present disclosure, the process of performing audio synthesis processing on the second human voice audio may be as shown in FIG. 6. After the reference audio is obtained, music source separation processing is performed on the reference audio to obtain the first human voice audio and the accompaniment audio. The first loudness range, stereophonic sound, and the first spectral distribution corresponding to the first frequency band interval of the first human voice audio are respectively determined.

After the second human voice audio is obtained, the second loudness range of the second human voice audio is determined, and the loudness of the second human voice audio is dynamically adjusted based on the first comparison result between the second loudness range and the first loudness range to obtain the first target human voice audio which is then mixed with the accompaniment audio to obtain the target audio. The channel separation processing is performed on the reference audio to obtain the first audio corresponding to the left channel and the second audio corresponding to the right channel, and the first channel energy of the first audio and the second channel energy of the second audio are determined. The channel separation processing is performed on the target audio to obtain the third audio corresponding to the left channel and the fourth audio corresponding to the right channel, and then the targeted adjustment is performed on the third audio and the fourth audio based on the first channel energy, the second channel energy, and the third comparison result between the first channel energy and the second channel energy to obtain the second target audio. Moreover, the spectral distribution of the second target audio is adjusted based on the spectral distribution of the reference audio to obtain the first target audio.

Further, in order to optimize the first target audio, the spectral distribution corresponding to the first frequency band interval in the first target audio is adjusted based on the first spectral distribution corresponding to the first frequency band interval in the first human voice audio, so as to obtain the final synthesized audio.

By the above music synthesis method, automatic processing for audio synthesis can be achieved, and the synthesis efficiency of the audio can be improved. Moreover, through accurate spectral processing and dynamic range optimization, the quality and auditory effect of the final synthesized audio can also be effectively improved, so that the synthesized audio is closer to the audio characteristic of the reference frequency and meets the expectation for synthesis.

In this example, an audio synthesis apparatus is further provided. The apparatus is used for implementing the above examples and preferred embodiments, which will not be described in detail as already described. As used hereinafter, the term “module” may implement a combination of software and/or hardware for a predetermined function. Although the apparatus described in the following example is preferably implemented by software, implementations by hardware, or a combination of software and hardware, are also possible and are contemplated.

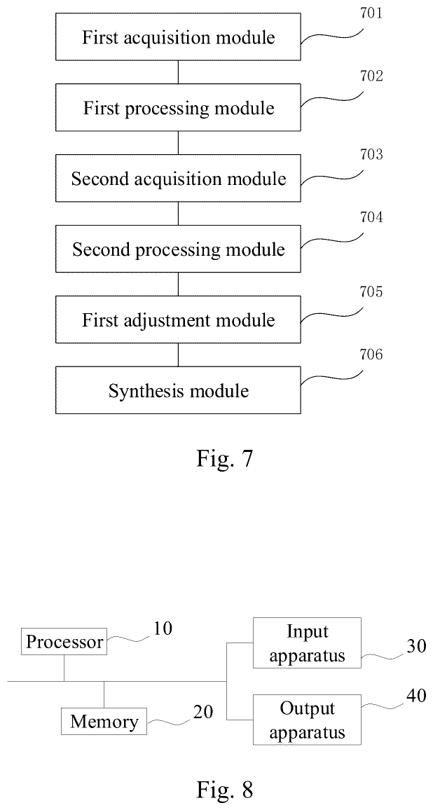

This example provides an audio synthesis apparatus, as shown in FIG. 7, including:
a first acquisition module 701 configured to acquire first human voice audio and accompaniment audio in reference audio;
a first processing module 702 configured to determine a first loudness range based on loudness of the first human voice audio;
a second acquisition module 703 configured to acquire second human voice audio corresponding to the reference audio;
a second processing module 704 configured to determine a second loudness range based on loudness of the second human voice audio;
a first adjustment module 705 configured to adjust the loudness of the second human voice audio based on a first comparison result between the second loudness range and the first loudness range to obtain first target human voice audio; and

a synthesis module 706 configured to mix the first target human voice audio and the accompaniment audio to obtain target audio.

In some optional embodiments, the first adjustment module 705 includes:
a first processing unit configured to determine a maximum signal decibel value corresponding to the first human voice audio, and determining a signal compression threshold based on the maximum signal decibel value;
a second processing unit configured to determine a signal compression ratio according to a ratio of the second loudness range to the first loudness range; and
a first adjustment unit configured to: adjust, in response to a decibel value of a current second human voice audio signal being greater than the signal compression threshold, and based on a first difference value between the decibel value of the current second human voice audio signal and the signal compression threshold and the signal compression ratio, loudness of the current second human voice audio signal to obtain first target human voice audio.

In some optional embodiments, the first adjustment module 705 further includes:
a first execution unit configured to: perform, in response to the decibel value of the current second human voice audio signal being less than or equal to the signal compression threshold, not loudness adjustment processing on the current second human voice audio signal.

In some optional embodiments, the synthesis module 706 includes:
a first basing unit configured to determine first spectral distribution corresponding to a first frequency band interval based on spectral distribution of the first human voice audio;
a second basing unit configured to determine second spectral distribution corresponding to the first frequency band interval based on spectral distribution of the first target human voice audio; and
a second adjustment unit configured to adjust the second spectral distribution based on the first spectral distribution to obtain second target human voice audio for being mixed with the accompaniment audio to obtain the target audio.

In some optional embodiments, the second adjustment unit includes:
a first determination unit configured to determine a first spectral initial value of the first spectral distribution;
a second execution unit configured to: determine, in response to a current second spectral value being greater than the first spectral initial value, a second difference value between the current second spectral value and the first spectral initial value;
a third execution unit configured to adjust the current second spectral value based on the second difference value and a specified enhancement factor to obtain third spectral distribution; and
a third processing unit configured to obtain the second target human voice audio based on the third spectral distribution.

In some optional embodiments, the second adjustment unit further includes:
a fourth execution unit configured to: adjust, in response to the current second spectral value being less than or equal to the first spectral initial value, not the current second spectral value.

In some optional embodiments, the third processing unit includes:
a fifth execution unit configured to determine target harmonic energy based on first harmonic spectral distribution of the first human voice audio;
a sixth execution unit configured to determine second harmonic spectral distribution in the third spectral distribution; and
a seventh execution unit configured to determine a harmonic adjustment order based on the target harmonic energy, and adjusting the second harmonic spectral distribution based on the harmonic adjustment order and a specified adjustment factor to obtain the second target human voice audio.

In some optional embodiments, the third processing unit further includes:
an eighth execution unit configured to obtain first phase distribution based on a spectral phase of the first spectral distribution;
a ninth execution unit configured to obtain second phase distribution corresponding to the first frequency band interval and third phase distribution corresponding to a second frequency band interval based on a spectral phase of the third spectral distribution, a frequency value in the second frequency band interval being less than a frequency value in the first frequency band interval; and
a tenth execution unit configured to adjust the second phase distribution based on the first phase distribution and the third phase distribution to obtain the second target human voice audio.

In some optional embodiments, the apparatus further includes:
a third processing module configured to obtain fourth spectral distribution based on spectral distribution of the reference audio, and determining first reference spectral energy of a main frequency band corresponding to the reference audio;
a fourth processing module configured to obtain fifth spectral distribution based on spectral distribution of the target audio, and determining second reference spectral energy of a main frequency band corresponding to the target audio;
a second adjustment module configured to adjust spectral energy distribution of the target audio based on a ratio of the fourth spectral distribution to the fifth spectral distribution to obtain first intermediate audio; and
a third adjustment module configured to adjust spectral energy distribution of the first intermediate audio based on a comparison result between the first reference spectral energy and the second reference spectral energy to obtain first target audio.

In some optional embodiments, the apparatus further includes:
a separation processing module configured to perform channel separation processing on the reference audio to obtain first audio corresponding to a left channel and second audio corresponding to a right channel;
a fifth processing module configured to determine first channel energy of the first audio, and second channel energy of the second audio; and
a fourth adjustment module configured to adjust the target audio based on the first channel energy, the second channel energy, and a third comparison result between the first channel energy and the second channel energy to obtain second target audio.

In some optional embodiments, the fourth adjustment module includes:
a fifth processing unit configured to perform channel separation processing on the target audio to obtain third audio corresponding to the left channel and fourth audio corresponding to the right channel;
a sixth processing unit configured to determine first target gain corresponding to the left channel based on the third comparison result and a ratio of the first channel energy to the second channel energy;
a seventh processing unit configured to determine second target gain corresponding to the right channel based on the third comparison result and a ratio of the second channel energy to the first channel energy; and
an eighth processing unit configured to adjust the third audio by the first target gain and adjusting the fourth audio by the second target gain respectively to obtain second target audio.

In some optional embodiments, the eighth processing unit includes:
a third adjustment unit configured to adjust the third audio using the first target gain to obtain fifth audio;
a fourth adjustment unit configured to adjust the fourth audio using the second target gain to obtain sixth audio;
a relationship determination unit configured to determine a cross-correlation relationship between the first audio and the second audio; and
a fifth adjustment unit configured to adjust a time difference between the fifth audio and the sixth audio based on the cross-correlation relationship to obtain the second target audio.

Further functional description of the various modules and units described above are the same as the description in the corresponding examples described above, which will not be described in detail herein.

The audio synthesis apparatus in this example is presented in the form of functional units, and the units herein refer to application specific integrated circuits (ASICs), processors for executing one or more software or fixed programs and memories, and/or other devices which may provide the functions described above.

An example of the present disclosure further provides an electronic device having the above audio synthesis apparatus shown in FIG. 7.

With reference to FIG. 8, FIG. 8 is a schematic structural diagram of an electronic device provided in an optional example of the present disclosure, and as shown in FIG. 8, the electronic device includes: one or more processors 10, a memory 20, and interfaces for connecting various components, including high-speed interfaces and low-speed interfaces. The various components are communicatively connected to one another by utilizing different buses, and may be mounted on a common motherboard or otherwise as desired. The processors may process instructions executed inside the electronic device, including instructions stored in the memory or on the memory to display graphical information of a GUI on an external input/output device (such as a display device coupled to the interface). In some optional embodiments, a plurality of processors and/or a plurality of buses may be used together with a plurality of memories in response to needs. Similarly, a plurality of electronic devices may be connected, and various devices provide part of necessary operation (such as, as a server array, a set of blade servers, or a multi-processor system). One processor 10 is taken for an example in FIG. 8.

The processor 10 may be a central processor, a network processor, or a combination thereof, wherein the processor 10 may further include a hardware chip. The above hardware chip may be an application specific integrated circuit, a programmable logic device, or a combination thereof. The above programmable logic device may be a complex programmable logic device, a field programmable gate array, generic array logic, or any combination thereof.

Wherein the memory 20 stores instructions executable by at least one processor 10 to cause the at least one processor 10 to execute and implement the method shown in the above examples.

The memory 20 may include a program storage area and a data storage area, wherein the program storage area may store an operating system and an application program required by at least one function; and the data storage area may store data created according to the use of the electronic device, and the like. In addition, the memory 20 may include a high-speed random access memory, and may further include a non-transitory memory, such as at least one magnetic disk storage device, a flash memory device, or other non-transitory solid-state storage devices. In some optional embodiments, the memory 20 optionally includes memories remotely provided with respect to the processor 10, and these remote memories may be connected to the electronic device via networks. Instances of the above networks include, but are not limited to, the Internet, intranets, local area networks, mobile communication networks, and combinations thereof.

The memory 20 may include a volatile memory, such as a random access memory; the memory may also include a non-volatile memory, such as a flash memory, a hard disk or a solid-state hard disk; and the memory 20 may further include a combination of the memories of the above types.

The electronic device further includes an input apparatus 30 and an output apparatus 40. The processor 10, the memory 20, the input apparatus 30, and the output apparatus 40 may be connected by a bus or otherwise. Connection by the bus is taken for an example in FIG. 8.

The input apparatus 30 may receive the input number or character information and generate key signal inputs related to user settings and function controls of the electronic device, such as a touch screen, a keypad, a mouse, a track pad, a touch pad, a pointing stick, one or more mouse buttons, a track ball, and a joystick. The output apparatus 40 may include a display device, an auxiliary lighting apparatus (such as an LED), and a haptic feedback apparatus (such as a vibration motor), and the like. The above display device includes, but is not limited to, a liquid crystal display, a light emitting diode, a display, and a plasma display. In some optional embodiments, the display device may be a touch screen.

An example of the present disclosure further provides a computer-readable storage medium. The above method according to the example of the present disclosure may be implemented in hardware and firmware, or implemented as computer codes which may be recorded in the storage medium, or downloaded via a network, originally stored in a remote storage medium or a non-transitory machine-readable storage medium and to be stored in a local storage medium, so that the method described herein may be processed by such software stored on a storage medium using a general-purpose computer, a dedicated processor, or programmable or dedicated hardware, wherein the storage medium may be a diskette, an optical disk, a read-only storage memory, a random storage memory, a flash memory, a hard disk, or a solid-state hard disk, and the like; further, the storage medium may further include a combination of the memories of the above types. It will be understood that a computer, a processor, a microprocessor controller, or programmable hardware includes storage components which may store or receive software or computer codes, wherein the software or computer codes, when accessed and executed by the computer, the processor, or the hardware, implement the method shown in the above example.

A part of the present disclosure may be applied as a computer program product, such as computer program instructions which, when executed by the computer, may invoke or provide the method and/or technical solution according to the present disclosure through the operation of the computer. It will be understood by those skilled in the art that the computer program instructions may exist in a computer-readable medium in the forms including, but not limited to, source files, executable files, installation package files, and the like. Accordingly, the manner in which the computer program instructions are executed by the computer includes, but is not limited to: the computer directly executes the instructions, or the computer compiles the instructions and then executes the corresponding compiled programs, or the computer reads and executes the instructions, or the computer reads and installs the instructions and then executes the corresponding installed programs. Herein, the computer-readable medium may be any available computer-readable storage medium or communication medium accessible by the computer.

It will be understood that prior to using the technical solutions disclosed in the various examples of the present disclosure, a user should be informed of the type, use range, use scene, and the like of personal information involved in the present disclosure and be authorized by the user in an appropriate manner in accordance with relevant laws and regulations.

For example, in response to receiving an active request of the user, prompt information is sent to the user to explicitly prompt the user that the operation requested to be executed will require the acquisition and use of the personal information of the user. Thus, the user may autonomously select whether to provide the personal information to software or hardware, such as an electronic device, an application program, a server, or a storage medium, which executes the operation of the technical solution of the present disclosure, according to the prompt information.

As an optional but non-limiting implementation mode, in response to receiving the active request of the user, the manner in which the prompt information is sent to the user may be, for example, a pop-up window in which the prompt information may be presented in text. In addition, the pop-up window may also carry a selection control for the user to select either “agree” or “disagree” to provide the personal information to the electronic device.

It will be understood that the above processes of notification and acquisition of user authorization are merely illustrative and are not limiting of the implementation mode of the present disclosure, as other manner satisfying relevant laws and regulations may also be applied in the implementation mode of the present disclosure.

Although the embodiments of the present disclosure have been described in conjunction with the accompanying drawings, those skilled in the art can make various modifications and variations without departing from the spirit and scope of the present disclosure, and such modifications and variations all fall within the scope defined by the appended claims.

1. An audio synthesis method, comprising:
acquiring a first human voice audio and an accompaniment audio from reference audio;
determining a first loudness range based on loudness of the first human voice audio;
acquiring second human voice audio corresponding to the reference audio;
determining a second loudness range based on loudness of the second human voice audio;
adjusting the loudness of the second human voice audio based on a first comparison result between the second loudness range and the first loudness range to obtain first target human voice audio; and
mixing the first target human voice audio and the accompaniment audio to obtain target audio.

2. The method according to claim 1, wherein the adjusting the loudness of the second human voice audio based on the first comparison result between the second loudness range and the first loudness range to obtain the first target human voice audio comprises:
determining a maximum signal decibel value corresponding to the first human voice audio, and determining a signal compression threshold based on the maximum signal decibel value;
determining a signal compression ratio according to a ratio of the second loudness range to the first loudness range; and
adjusting, in response to a decibel value of a current second human voice audio signal being greater than the signal compression threshold, and based on a first difference value between the decibel value of the current second human voice audio signal and the signal compression threshold and the signal compression ratio, loudness of the current second human voice audio signal to obtain first target human voice audio, wherein the current second human voice audio signal is one of audio signals in the second human voice audio.

3. The method according to claim 2, wherein the adjusting the loudness of the second human voice audio based on the first comparison result between the second loudness range and the first loudness range to obtain the first target human voice audio further comprises:
performing, in response to the decibel value of the current second human voice audio signal being less than or equal to the signal compression threshold, no loudness adjustment processing on the current second human voice audio signal.

4. The method according to claim 1, wherein the mixing the first target human voice audio and the accompaniment audio to obtain the target audio comprises:
determining first spectral distribution corresponding to a first frequency band interval based on spectral distribution of the first human voice audio;
determining second spectral distribution corresponding to the first frequency band interval based on spectral distribution of the first target human voice audio; and
adjusting the second spectral distribution based on the first spectral distribution to obtain second target human voice audio for being mixed with the accompaniment audio to obtain the target audio.

5. The method according to claim 4, wherein the adjusting the second spectral distribution based on the first spectral distribution to obtain the second target human voice audio comprises:
determining a first spectral initial value of the first spectral distribution;
determining, in response to a current second spectral value being greater than the first spectral initial value, a second difference value between the current second spectral value and the first spectral initial value, wherein the current second spectral value is one of spectral values in the second spectral distribution;
adjusting the current second spectral value based on the second difference value and a specified enhancement factor to obtain third spectral distribution; and
obtaining the second target human voice audio based on the third spectral distribution.

6. The method according to claim 5, wherein the adjusting the second spectral distribution based on the first spectral distribution to obtain the second target human voice audio further comprises:
adjusting, in response to the current second spectral value being less than or equal to the first spectral initial value, not the current second spectral value.

7. The method according to claim 5, wherein the obtaining the second target human voice audio based on the third spectral distribution comprises:
determining target harmonic energy based on first harmonic spectral distribution of the first human voice audio;
determining second harmonic spectral distribution in the third spectral distribution;
determining a harmonic adjustment order based on the target harmonic energy; and
adjusting the second harmonic spectral distribution based on the harmonic adjustment order and a specified adjustment factor to obtain the second target human voice audio.

8. The method according to claim 7, wherein the obtaining the second target human voice audio based on the third spectral distribution further comprises:
obtaining first phase distribution based on a spectral phase of the first spectral distribution;
obtaining second phase distribution corresponding to the first frequency band interval and third phase distribution corresponding to a second frequency band interval based on a spectral phase of the third spectral distribution, wherein a frequency value in the second frequency band interval is less than a frequency value in the first frequency band interval; and
adjusting the second phase distribution based on the first phase distribution and the third phase distribution to obtain the second target human voice audio.

9. The method according to claim 1, further comprising:
obtaining fourth spectral distribution based on spectral distribution of the reference audio, and determining first reference spectral energy of a main frequency band corresponding to the reference audio;
obtaining fifth spectral distribution based on spectral distribution of the target audio, and determining second reference spectral energy of a main frequency band corresponding to the target audio;
adjusting spectral energy distribution of the target audio based on a ratio of the fourth spectral distribution to the fifth spectral distribution to obtain first intermediate audio; and
adjusting spectral energy distribution of the first intermediate audio based on a second comparison result between the first reference spectral energy and the second reference spectral energy to obtain first target audio.

10. The method according to claim 1, further comprising:
performing channel separation processing on the reference audio to obtain first audio corresponding to a left channel and second audio corresponding to a right channel;
determining first channel energy of the first audio, and second channel energy of the second audio; and
adjusting the target audio based on the first channel energy, the second channel energy, and a third comparison result between the first channel energy and the second channel energy to obtain second target audio.

11. The method according to claim 10, wherein the adjusting the target audio based on the first channel energy, the second channel energy, and the third comparison result between the first channel energy and the second channel energy to obtain the second target audio, comprises:
performing channel separation processing on the target audio to obtain third audio corresponding to the left channel and fourth audio corresponding to the right channel;
determining first target gain corresponding to the left channel based on the third comparison result and a ratio of the first channel energy to the second channel energy;
determining second target gain corresponding to the right channel based on the third comparison result and a ratio of the second channel energy to the first channel energy; and
adjusting the third audio by the first target gain and adjusting the fourth audio by the second target gain respectively to obtain the second target audio.

12. The method according to claim 11, wherein the adjusting the third audio by the first target gain and adjusting the fourth audio by the second target gain respectively to obtain the second target audio comprises:
adjusting the third audio using the first target gain to obtain fifth audio;
adjusting the fourth audio using the second target gain to obtain sixth audio;
determining a cross-correlation relationship between the first audio and the second audio; and
adjusting a time difference between the fifth audio and the sixth audio based on the cross-correlation relationship to obtain the second target audio.

13. An electronic device, comprising:
a memory; and
a processor,
wherein the memory and the processor are communicatively connected to each other, the memory comprises computer instructions stored therein, and the computer instructions upon executed by the processor, causes the processor to execute an audio synthesis method, and the method comprises:
acquiring a first human voice audio and an accompaniment audio from reference audio;
determining a first loudness range based on loudness of the first human voice audio;
acquiring second human voice audio corresponding to the reference audio;
determining a second loudness range based on loudness of the second human voice audio;
adjusting the loudness of the second human voice audio based on a first comparison result between the second loudness range and the first loudness range to obtain first target human voice audio; and
mixing the first target human voice audio and the accompaniment audio to obtain target audio.

14. The electronic device according to claim 13, wherein the adjusting the loudness of the second human voice audio based on the first comparison result between the second loudness range and the first loudness range to obtain the first target human voice audio, comprises:
determining a maximum signal decibel value corresponding to the first human voice audio, and determining a signal compression threshold based on the maximum signal decibel value;
determining a signal compression ratio according to a ratio of the second loudness range to the first loudness range; and
adjusting, in response to a decibel value of a current second human voice audio signal being greater than the signal compression threshold, and based on a first difference value between the decibel value of the current second human voice audio signal and the signal compression threshold and the signal compression ratio, loudness of the current second human voice audio signal to obtain first target human voice audio, wherein the current second human voice audio signal is one of audio signals in the second human voice audio.

15. The electronic device according to claim 14, wherein the adjusting the loudness of the second human voice audio based on the first comparison result between the second loudness range and the first loudness range to obtain the first target human voice audio, further comprises:
performing, in response to the decibel value of the current second human voice audio signal being less than or equal to the signal compression threshold, no loudness adjustment processing on the current second human voice audio signal.

16. The electronic device according to claim 13, wherein the mixing the first target human voice audio and the accompaniment audio to obtain the target audio, comprises:
determining first spectral distribution corresponding to a first frequency band interval based on spectral distribution of the first human voice audio;
determining second spectral distribution corresponding to the first frequency band interval based on spectral distribution of the first target human voice audio; and
adjusting the second spectral distribution based on the first spectral distribution to obtain second target human voice audio for being mixed with the accompaniment audio to obtain the target audio.

17. The electronic device according to claim 16, wherein the adjusting the second spectral distribution based on the first spectral distribution to obtain the second target human voice audio, comprises:
determining a first spectral initial value of the first spectral distribution;
determining, in response to a current second spectral value being greater than the first spectral initial value, a second difference value between the current second spectral value and the first spectral initial value, wherein the current second spectral value is one of spectral values in the second spectral distribution;
adjusting the current second spectral value based on the second difference value and a specified enhancement factor to obtain third spectral distribution; and
obtaining the second target human voice audio based on the third spectral distribution.

18. The electronic device according to claim 17, wherein the adjusting the second spectral distribution based on the first spectral distribution to obtain the second target human voice audio, further comprises:
adjusting, in response to the current second spectral value being less than or equal to the first spectral initial value, not the current second spectral value.

19. The electronic device according to claim 17, wherein the obtaining the second target human voice audio based on the third spectral distribution, comprises:
determining target harmonic energy based on first harmonic spectral distribution of the first human voice audio;
determining second harmonic spectral distribution in the third spectral distribution;
determining a harmonic adjustment order based on the target harmonic energy; and
adjusting the second harmonic spectral distribution based on the harmonic adjustment order and a specified adjustment factor to obtain the second target human voice audio.

20. A non-transitory computer-readable storage medium, having computer instructions stored thereon, wherein the computer instructions are configured to cause a computer to execute an audio synthesis method, and the method comprises:
acquiring a first human voice audio and an accompaniment audio from reference audio;
determining a first loudness range based on loudness of the first human voice audio;
acquiring second human voice audio corresponding to the reference audio;
determining a second loudness range based on loudness of the second human voice audio:
adjusting the loudness of the second human voice audio based on a first comparison result between the second loudness range and the first loudness range to obtain first target human voice audio; and
mixing the first target human voice audio and the accompaniment audio to obtain target audio.
